(19) United States
(12) Patent Application Publication
(10) Pub. No.: US 2022/0126239 A1
(43) Pub. Date: Apr. 28, 2022

(54) FILTER SYSTEM

(71) Applicant: Fabio and Markus Membrane Engineering GmbH, Freienbach (CH)

(72) Inventor: Fabio HÜTHER, Ermatingen (CH)

(73) Assignee: Fabio and Markus Membrane Engineering GmbH, Freienbach (CH)

(21) Appl. No.: 17/435,438

(22) PCT Filed: Feb. 28, 2020
(86) PCT No.: PCT/EP2020/055357

§ 371 Date: Sep. 1, 2021

(30) Foreign Application Priority Data
Mar. 1, 2019 (CH) 00253/19

(51) Int. Cl. B01D 63/10

(52) U.S. Cl. CPC B01D 63/10; B01D 2313/08; B01D 2313/04

(57) ABSTRACT

The filter system includes a feed hose (10) arranged along a permeate hose (20), wherein the feed hose (10) and the permeate hose (20) include a membrane (7) as the common wall section, and wherein the permeate hose (20) is closed at the front end and includes a permeate outlet (29) at the rear end. A fluid to be prepared flows in a pressurized state through the feed hose (10). At the end of the feed hose, a first fraction of the fluid flows through a retentate outlet (25) out of the feed hose (10). A further fraction of the fluid moves through pores of the membrane (7) into the permeate hose (20). This fraction flows through a permeate outlet (25) at the end of the permeate hose (20), separate from the retentate, and out of the filter system.

### TECHNICAL FIELD

The field of the invention is a filter system for preparing water and a method for preparing a liquid.

### BACKGROUND

To prepare liquids, in particular water, it is known to use filter systems, in the case of which one or several filter elements are wound spirally around a collector tube.

The filter elements comprise a porous membrane, which is generally embedded between further layers, and which limits a tubular flow chamber. The stacked layers of each filter element can be sealingly connected to one another, e.g., along the longitudinal edges. Depending on the pore size of the membrane, such filter elements can be used for the microfiltration (pore size>=0.1 μm), for the ultrafiltration (0.002 μm=<pore size<0.1 μm), or for the nanofiltration (pore size<0.002 μm).

The wall of the collector tube comprises collector openings, through which the filtered liquid, also called permeate, can be guided out of the flow chamber of each filter element into the collector tube. Such assemblies are also referred to as wound module.

Each wound module is usually installed coaxially into a cylindrical housing, wherein the ends of the collector tube protrude beyond the housing on the front side at the ends of the housing. At each of the two front-side ends, the housing comprises a cover, which is permeated by a section of the collector tube.

Peripherally to the collector tube, each of the covers comprises at least one passage opening. Via the passage opening at the one end, the liquid to be prepared, also called feed, is introduced under pressure into the housing and is thus fed to the filter system. Via the passage opening at the opposite other end, the concentrate, thus that fraction or that portion of the liquid, respectively, which has not passed through the membrane, is discharged from the housing. This portion of the liquid is also referred to as retentate.

Such filter systems are operated in the crossflow process. The liquid to be purified is pressed on the front side into the intermediate spaces between the layers of the wound-up filter element. A seal prevents that the liquid to be prepared between the outer side of the wound module and the housing wall can reach from the input-side passage opening to the output-side passage opening.

A portion of the liquid stream is guided through between the layers of the wound-up filter element in the axial direction, and escapes from the wound module again at the opposite end as retentate with increased concentration of particles, which cannot permeate the membrane due to their size.

According to the principle of reverse osmosis, the remaining portion of the pressurized liquid stream permeates the membrane radially or transversely, respectively, to the feed as further fraction. This portion of the liquid stream is called permeate or filtrate. The permeate does not contain any portions of the liquid stream, which cannot permeate the pores of the membrane due to their size. The permeate is guided between the layers of the filter element, thus in the tubular flow chamber, to the collector tube, and can enter into the collector tube there through the collector openings, and can be discharged as purified liquid.

A disadvantage of such conventional filter systems is that the ratio of permeate stream to retentate stream is comparatively small when purifying a liquid. The effectiveness or the efficiency, respectively, of such filter systems are comparatively small. In particular when the liquid to be purified is treated by means of prefilters, this results in a high maintenance effort at these prefilters. In addition, the pores of such filter systems can clog easily. At the respective liquid pressure, the flow rate thus changes, and the efficiency of the system decreases.

### SUMMARY

It is therefore the object of the invention to create a filter system and a method for the efficient preparation of liquids, such as, e.g., water.

This object is solved by a filter system and by a method for preparing liquids including one or more of the features disclosed herein.

The filter system comprises at least one filter membrane comprising pores. The maximum pore size is specified according to the respective intended purpose. It can in particular be greater than or equal to 0.1 μm, or can be between 0.002 μm and 0.1 μm, or can be smaller than 0.002 μm. One side of this filter membrane limits a primary flow chamber, the other side limits a secondary flow chamber. The flow chambers are limited by walls, which are formed in a tubular manner comprising a front end and a rear end. The filter membrane is a separating layer between these two flow chambers and thus a common part of the walls of both flow chambers.

The two flow chambers can be arranged, e.g., next to one another, wherein the filter membrane is a common section of the walls of each of the flow chambers. The filter membrane can in particular be formed as hose, which completely encases the primary flow chamber or the secondary flow chamber.

The flow chambers can also be formed in the manner of two hoses, which are placed one on top of the other, wherein the inner flow chamber is partly or completely limited by the filter membrane. The internal flow chamber is preferably the primary flow chamber.

At the front end, the primary flow chamber comprises a feed inlet, and at the rear end a retentate outlet. These openings define a flow direction for the feed in the longitudinal direction of the hoses.

At the rear end, the secondary flow chamber comprises a permeate outlet. The front end of the secondary flow chamber is closed. A portion of the liquid can reach as permeate from the liquid stream in the primary flow chamber through the pores into the secondary flow chamber. The liquid pressure in the primary flow chamber or the pressure difference between the primary and the secondary flow chamber, respectively, is the driving force thereby. Due to the fact that the membrane extends essentially over the entire length of the flow chambers, permeate can be driven into the secondary flow chamber essentially along the entire length of the primary flow chamber.

In the secondary flow chamber, the permeate streams to the permeate outlet, where it can be discharged separately from the retentate. The flow direction corresponds to that of the feed in the primary flow chamber.

The filter system preferably comprises a housing, in which one or several filter elements are arranged, which limit one or several flow chambers.

Each filter element comprises a membrane and has the shape of a hose-like flat structure, which is closed or sealed along its longitudinal edges. The membrane itself can thereby be formed as hose, which is folded along two longitudinal edges. The hose can be formed, e.g., in a seamless manner. In the alternative, the hose can also be produced by means of connection of one or several layers, along at least one strip. At least one of these layers is thereby a membrane layer. The connection of the layers can take place, e.g., by means of adhesion or fusion.

In the case of multi-layer filter elements, at least the outer ones of these layers can be connected to one another along the longitudinal edges, e.g. by means of a sealing tape or by means of fusion, so that, together, they form a hose. Adjacent to at least one of the two surfaces of the membrane, a liquid-permeable layer can be arranged in the interior of the hose and/or on the outer side thereof. Such layers act as spacers and ensure that sufficient space for the respective liquid stream along the membrane is available in the hose and/or in the intermediate space between the spirally wound-up layers of the filter element. In the alternative, spacers can also be structures, which protrude at the surface of the membrane or a layer adjacent to the membrane.

The housing comprises at least one input opening, which is connected to the feed inlet of each filter element. Analogously thereto, the retentate outlet of each filter element is connected to at least one output opening of the housing. The permeate outlet of each filter element is connected to a filtrate opening of the housing in an analogous manner. The housing regions, in which the input opening, the output opening and the filtrate opening are arranged, are not directly connected to one another.

The filter system preferably comprises means, which limit the flow cross section of the primary flow chamber. It is thus ensured that the ratio of effective membrane surface to the volume of the primary flow chamber is comparatively large, and the efficiency of the filter system is correspondingly high. Moreover, a smaller flow cross section with the same volume flow in the primary flow chamber effects a larger flow speed. The deposition of particles on the inner wall of the flow chamber can thus be effectively prevented. The risk of a clogging of pores of the membrane can in particular be minimized in this way.

The limitation of the flow cross section in the primary flow chamber can in particular take place in that one or several hose-like, limp filter elements are wound up spirally. In the case of each filter element, the height of the flow chambers is thus limited by means of adjoining layers of one or several filter elements. In the alternative or in addition, the height of the flow chambers can also be limited by means of the wall of the housing. In the case of filter systems comprising one or several stacked filter elements, this is also possible when the flat filter elements are not wound up. The housings can have cylindrical or non-cylindrical, e.g. cuboid designs. The housing design can in particular be adapted to the structural conditions of different application sites. This provides for or facilitates the installation of such filter systems at different points of use, for example in the case of water connections in houses, in the case of fittings in kitchens and bathrooms, in the case of lines of water-bearing devices, such as, e.g., coffee makers, dishwashers, washing machines and the like, or in the case of water treatment plants, in particular of swimming pools and hospitals.

The filter system preferably comprises means, which ensure a minimal flow cross section in the primary flow chamber and/or in the secondary flow chamber. Such means are in particular liquid-permeable layers, such as, e.g., nets, meshes, non-woven fabrics or woven fabrics. In the alternative, the walls of flow chambers can comprise structures protruding into the respective flow chamber, such as, e.g., ribs running in the longitudinal direction, at which particles from the liquid can barely deposit.

In the case of preferred embodiments, the filter system comprises a wound module comprising one or several filter elements, which are wound spirally around a collector tube.

The intermediate spaces between the filter element layers adjacent to one another are closed along the longitudinal edges of each filter element by means of a sealing means. Together with the sealing means, two adjoining filter element layers in each case limit hose-like primary flow chambers.

The sealing means can comprise, e.g., seals, which are arranged directly on the front sides of the wound module, in particular elastic sealing cords, which are pressed into the spiral gap openings or which are connected in another way to filter elements in the region of the longitudinal edges. In the alternative, sealing bodies can be cast integrally, molded integrally or pressed integrally to the front sides of the wound module. Such sealing bodies can in particular be made of food-compatible silicone. Each sealing body can be formed such that it completely seals the adjacent gap openings between the wound-up filter elements on the front side. In the alternative, at least one of the sealing bodies can be formed such that it only partially seals the adjoining gap openings. The input-side sealing body can in particular comprise at least one recess arranged radially on the outside or spaced apart from the central collector tube, respectively, as front-side feed inlet. In the alternative or in addition, the output-side sealing body can comprise at least one recess arranged radially on the inside or close to the collector tube, respectively, as front-side retentate outlet. The sizes of the recesses or of the non-sealed sections, respectively, at the feed inlet and at the retentate outlet influence flow parameters, such as, e.g., flow resistance, pressure, and flow speed of the liquid in the primary flow chamber. The lengths of the exposed feed inlet and/or of the exposed retentate outlet can lie, e.g., in the magnitude of approximately one-third up to approximately three-times the width of the primary flow chamber. Between the feed inlet and the retentate outlet, each primary flow chamber is preferably sealed over at least one-third of its total length.

In the case of wound modules, which are arranged in a housing, the sealing means can comprise, e.g., sealing bodies, which are pressed against the front sides of the wound module by means of housing covers and which thus partially or completely seal the gap openings between the individual layers on the front side. The input-side sealing bodies are formed such that liquid can flow through input openings into the housing and can reach into the primary feed hose or hoses, respectively, through at least one access opening on the front end of the at least one filter element. Such feed or access openings can be arranged on the front side on the wound module and/or peripherally on the jacket surface thereof.

The input openings at the housing can be arranged, e.g., on the front side or axially, respectively, on the housing cover or radially on the housing cover or radially on the jacket surface of the housing. In the alternative, a partition wall could be arranged in the interior of the collector tube, which partition wall divides the collector tube into a front section and a rear section, which is separated from the front section. In the case of such embodiments, the wall of the collector tube comprises recesses in the front section, which connect the input-side opening of the collector tube to the feed inlet of the wound module. The front section of the collector tube is accordingly used to feed the feed, but not to discharge permeate. At the rear end of the at least one filter element, the output-side sealing bodies preferably comprise an output opening, through which the retentate can escape from the primary feed hose near the collector tube.

At the collector tube-side end, the permeate hose comprises at least one opening. This opening is connected to the collector openings of the collector tube, so that the permeate stream can be introduced into the collector tube.

The feed hose is closed or sealed toward the collector tube. It is prevented thereby that liquid can enter directly from the feed hose into the collector tube. Near the internal rear end, the feed hose, by contrast, comprises at least one outlet opening or a retentate outlet, respectively. These openings provide for the front-side drainage of the concentrated retentate from the wound module.

### BRIEF DESCRIPTION OF THE DRAWINGS

The invention will be described in more detail below on the basis of some figures, in which

FIG. 1 shows a cut-open conventional wound module,

FIG. 2 shows an unwinding of a conventional wound module with delineated flow directions,

FIG. 3 shows an unwinding of a wound module according to the invention with delineated flow directions,

FIG. 4 shows a cutout of a simplified wound module in a first viewing direction,

FIG. 5 shows the cutout of the wound module from FIG. 4 in a second viewing direction,

FIG. 6 shows a cutout of a simplified wound module in a first viewing direction,

FIG. 7 shows the cutout of the wound module from FIG. 4 in a second viewing direction,

FIG. 8 shows a longitudinal section of a filter system.

### DETAILED DESCRIPTION

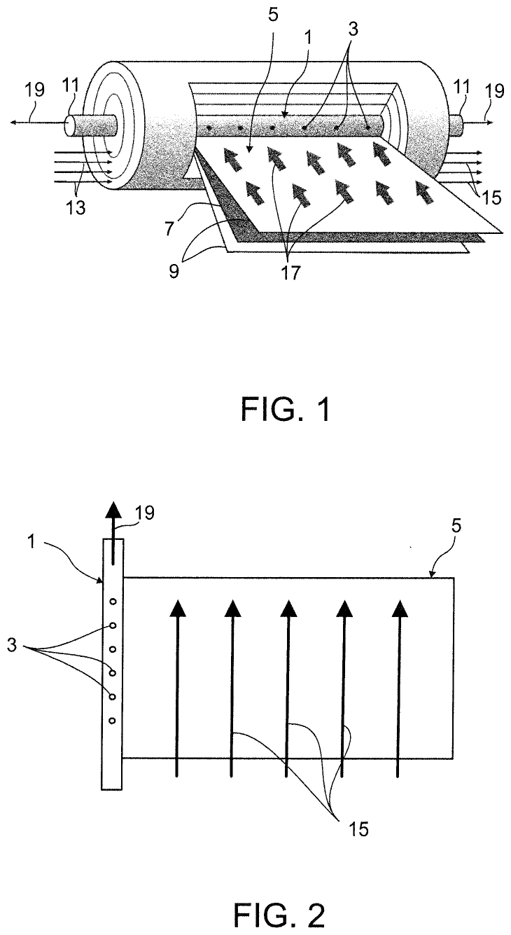

FIG. 1 shows a cut-open wound module of a known filter system. It comprises a central collector tube 1, the wall of which has several continuous collector openings 3. A multi-layer filter element 5, which comprises a membrane 7 and two further layers 9 adjacent to the membrane 7, is wound spirally around the collector tube 1. The ends of the collector tube 1 protrude beyond the wound-up filter element 5 on both front sides. The open ends of the collector tube 1 are filtrate outlets 11. The spiral intermediate space between the layers of the wound-up filter element 5 is open toward both front sides. The liquid to be purified streams as feed through this intermediate space in the axial direction. This is illustrated symbolically by means of feed arrows 13. On the opposite front side, a fraction of the feed streams out of the wound module in the axial direction. This is illustrated symbolically by means of retentate arrows 15. In the wound module, a fraction of the feed permeates small pores of the membrane 7 (not illustrated), and is guided spirally to the collector tube 1 as filtrate or permeate, respectively, on the opposite side of the membrane 7 transversely to the feed stream. This is illustrated symbolically by means of permeate arrows 17. There, the filtrate reaches through the collector openings 3 into the collector tube 1, and is subsequently discharged in the axial direction via the filtrate outlets 11. This is illustrated symbolically by means of arrows 19.

For illustration purposes, FIG. 2 shows the feed stream of such an arrangement when the filter element 5 is unwound.

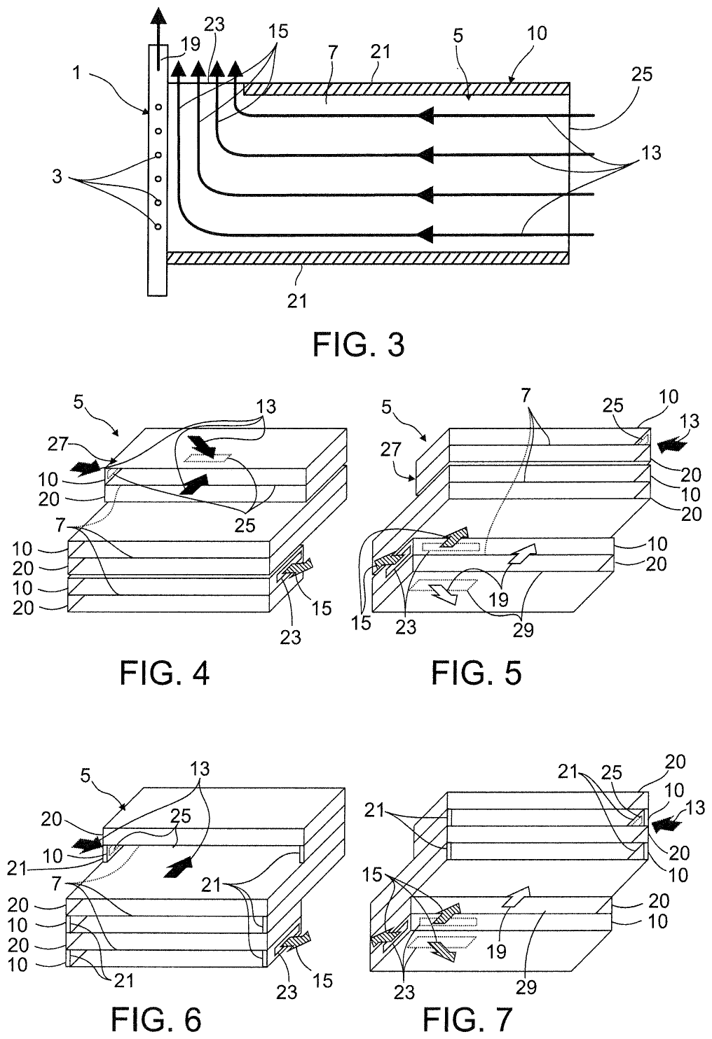

FIG. 3 shows the feed stream in the case of a filter system according to the present invention in an analogous manner. Along the two longitudinal edges of the filter element 5, strip-shaped sealing elements 21 are arranged such that they tightly close the intermediate spaces between adjacent layers of the filter element 5 on the front side at a wound module comprising wound-up filter element 5.

At least one of the sealing elements 21 does not extend over the entire length of the filter element 5. Adjacent to the collector tube 1, a comparatively small section of at least one of the longitudinal edges of the filter element 5 is formed without sealing element 21 at the rear end of the filter element 5. Adjacent to the collector tube 1, at least one retentate outlet 23, thus an opening, through which retentate can escape from a primary flow chamber, is thus created at a wound module comprising wound-up filter element 5. The primary flow chamber is the intermediate space between adjoining layers of the wound-up filter element 5. At the rear end of the filter element 5, the primary flow chamber is sealed off from the collector tube 1. At the front end, thus at the radially outer jacket surface of the wound module, the primary flow chamber between the sealing elements 21 comprises a tangentially accessible feed inlet 25.

In the alternative or in addition, a comparatively small section of at least one of the longitudinal edges of the filter element 5 could be formed without sealing element 21 at the front end of the filter element 5. In this case, the wound module has at least one feed inlet 25 (not illustrated), which is accessible on the front side. In the case of such embodiments of the wound module, the feed inlet 25, which is arranged tangentially on the jacket surface, can be tightly closed. This is advantageous in particular when the wound-up filter element or filter elements 5 of the wound module are encased and/or held together (not illustrated), e.g. by means of a protective film.

A simplified cutout of a wound module comprising three layers of a wound-up filter element 5 is illustrated in FIG. 4 with a view onto the front end of the filter element 5 and in FIG. 5 with a view onto the rear end of the filter element 5. The filter element 5 comprises a twin hose, wherein a feed hose 10, which limits a primary flow chamber, and a permeate hose 20, which limits a secondary flow chamber, are separated from one another by means of a porous membrane 7 within a tight covering hose 27. The open front end of the feed hose 10 is a feed inlet 25. In the alternative or in addition, feed inlets 25 on the front end of the filter element 5 can also be arranged laterally as openings in the wall of the covering hose 27, as is illustrated in FIG. 4 by means of dashed lines at a narrow side and at a broad side of the feed hose 10. The feed arrows 13 symbolically show the inflow of a liquid to be purified through the feed inlets 25 into the feed hose 10. The permeate hose 20 is closed at the front end. The open rear end of the permeate hose 20 is a permeate outlet 29. In the alternative or in addition, permeate outlets 29 at the rear end of the filter element 5 can also be arranged laterally as openings in the wall of the covering hose 27, as is illustrated in FIG. 5 by means of dashed lines on a narrow side and on a broad side of the permeate hose 20. The permeate arrows 19 symbolically show the outflow of the filtrate through the permeate outlets 29 from the permeate hose 20. The permeate outlets 29 are connected to the collector openings 3 of the collector tube 1 such that escaping permeate can be guided into the collector tube 1 separately from the feed and from the retentate (not illustrated). At the end of the feed hose 10, one or several openings are formed as retentate outlets 23 such that the retentate can be discharged from the feed hose 10 separately from the permeate. The retentate arrows 15 symbolically show the outflow of the retentate through the retentate outlets 23 out of the feed hose 10.

The filter element 5 can be wound onto the collector tube 1 such that the feed hose 10 is arranged radially on the outside or radially on the inside of the permeate hose 20.

In the feed hose 10 and/or in the permeate hose, structures can optionally be formed or liquid-permeable layers can be arranged as spacers, ensure the flow-through of liquid in the respective hose (not illustrated). Alternatively to a filter element 5, several filter elements 5 can also be wound spirally around the collector tube 1 jointly. In the case of the wound-up wound module, layers of different filter elements 5 are thus adjacent to one another. The feed inlets 25 of all filter elements 5 are preferably connected to a common input opening in a manner brought together in a housing. All retentate outlets 23 are analogously brought together and are connected to an output opening. The permeate outlets 23 connected accordingly to the collector tube 1, which comprises one or several openings as filtrate outlets 11.

Analogously to FIGS. 4 and 5, FIGS. 6 and 7 show a simplified cutout of a further wound module comprising three layers of a wound-up alternative filter element 5. In contrast to the embodiment according to FIGS. 4 and 5, the alternative filter element 5 comprises only a permeate hose 20. The feed hose 10 is created only when winding up the filter element 5 by sealing the intermediate space between the adjoining layers along the longitudinal edges of the filter element 5. The primary flow chamber is thus limited by means of two adjoining layers of the filter element 5 and by means of front-side sealing elements 21.

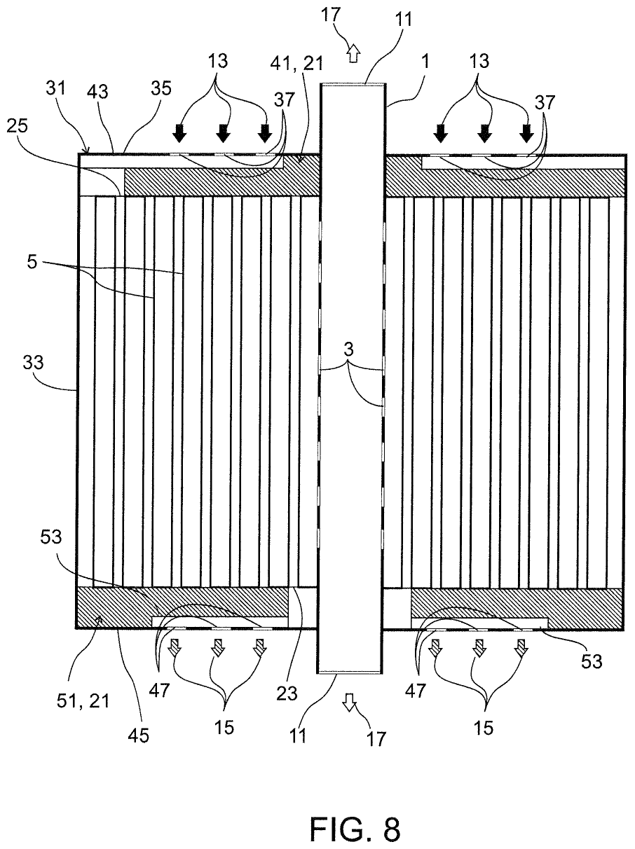

FIG. 8 shows a longitudinal section of a filter system, wherein a wound module is installed into an essentially cylindrical housing 31. The housing 31 is arranged coaxially to the collector tube 1. It comprises a cylindrical housing jacket 33, which encloses the wound module and which is covered on the front side by a cover 35 on the input side and by a cover 45 on the output side. The collector tube 1 permeates these covers 35 axially in both directions. The entry-side cover 35 comprises input openings 37, through which a liquid to be purified can flow as feed under pressure into the housing 31. Between the cover 35 and the front front side of the wound module, a front sealing body 41 as sealing element 21 covers the intermediate spaces between adjoining layers of one or several filter elements 5. The front sealing body 41 comprises at least one recess 43, which connects the input openings 37 to the feed inlet 25. The escape-side cover 45 comprises output openings 47, through which the retentate can flow out of the housing 31. Between the cover 45 and the rear front side of the wound module, a rear sealing body 51 as sealing element 21 covers the intermediate spaces between adjoining layers of the filter element or filter elements 5, respectively. The rear sealing body 51 comprises at least one recess 53, which connects the output openings 47 to the retentate outlet 23.

1. A filter system comprising:
at least one filter element (5), which comprises a permeate hose (20), said permeate hose (20) limits a secondary flow chamber, is closed at a front end thereof, and comprises a permeate outlet (29) at a rear end thereof,
at least a portion of the wall of said permeate hose (20) is a membrane (7) comprising pores, and the pores connect the secondary flow chamber to a primary flow chamber,
the membrane (7) is at least a part of a wall of a feed hose (10), which is arranged along the permeate hose (20) and which limits the primary flow chamber, and
the feed hose (10) comprises a feed inlet (25) at a front end thereof and a retentate outlet (23) spaced apart in a longitudinal direction of the feed hose (10) from the feed inlet, at a rear end thereof.

2. The filter system as claimed in claim 1, wherein the wall of the permeate hose (20) comprises an inner hose and an outer hose encasing the inner hose, and the inner hose forms the feed hose (10) comprising the membrane (7).

3. The filter system as claimed in claim 1, the wall of the feed hose (10) comprises an inner hose and an outer hose encasing the inner hose, wherein the inner hose forms the permeate hose (20) comprising the membrane (7).

4. The filter system as claimed in claim 1, wherein the feed hose (10) and the permeate hose (20) are arranged adjacently next to one another, and the membrane (7) is a common section of the walls of the feed hose (10) and of the permeate hose (20).

5. The filter system as claimed in claim 1, wherein the at least one filter element (5) is a wound module that is wound spirally around a collector tube (1) that includes collector openings (3), and the permeate outlet (29) at an inner side of the permeate hose (20) is arranged in a region of the collector tube (1) and is connected to the collector tube (1) via the collector openings (3).

6. The filter system as claimed in claim 5, wherein an intermediate space between adjoining layers of the at least one rolled-up filter element (5) at each of two front sides of the wound module is at least partially sealed by a sealing element (21).

7. The filter system as claimed in claim 6, wherein the primary flow chamber or the secondary flow chamber is limited by the adjoining layers of the at least one rolled-up filter element (5) and by the front-side sealing elements (21).

8. The filter system as claimed in claim 7, wherein the wound module is arranged in a housing (31), the housing (31) comprises a housing jacket (33), which is covered by an input-side cover (35) comprising at least one input opening (37) and by an output-side cover (45) comprising at least one output opening (47).

9. The filter system as claimed in claim 8, wherein at least one of (a) a front sealing body (41) is arranged between the input-side cover (35) and the wound module, said front sealing body seals the intermediate spaces between the adjoining layers of the at least one filter element (5) on a front side, and which comprises at least one recess (43), which connects the input opening (37) to the feed inlet (25), or (b) a rear sealing body (51) is arranged between the output-side cover (45) and the wound module, said rear sealing body seals the intermediate spaces between the adjoining layers of the at least one filter element (5) on a rear side, and which comprises at least one recess (53), which connects the output opening (47) to the retentate outlet (23).

10. A method for preparing a liquid using a filter system, wherein said filter system comprises a feed hose (10), which is arranged along a permeate hose (20), the permeate hose (20) is closed on a front end and comprises a permeate outlet (29) on a rear end, and a membrane (7) comprising pores is a common wall section of the feed hose (10) and of the permeate hose (20), the method comprising: the liquid flowing into the feed hose (10) under pressure through a feed inlet (23) at a front end of the feed hose, a fraction of the liquid flowing through the feed hose (10) along the permeate hose (20) and flowing out through a retentate opening (25) at an end of the feed hose (10), and a further fraction of the liquid moving through the pores of the membrane (7) into the permeate hose (20) and flowing out of the permeate hose (20) through the permeate outlet (29).
